(19) United States
(12) Patent Application Publication
(10) Pub. No.: US 2016/0197872 A1
(43) Pub. Date: Jul. 7, 2016

(54) PROVIDING CONTEXT FOR INSTANT MESSAGES

(71) Applicant: salesforce.com, inc., San Francisco, CA (US)

(72) Inventor: Naveen KHATTAR, Telengana (IN)

(21) Appl. No.: 14/591,235

(22) Filed: Jan. 7, 2015

(51) Int. Cl. H04L 12/58; G06F 17/30

(52) U.S. Cl. CPC H04L 51/32; H04L 51/04; G06F 17/30867

(57) ABSTRACT

A database system operates a feed system and communicates with different remote computing devices associated with different users. The database system may display feed items from the feed system on the remote computing devices and operate in conjunction with an instant message system. A first user while accessing the feed system may request an instant message communication with a second user to discuss one the feed items published on the feed system. The database system includes the context for the feed item in an instant message communication established between the first user and the second user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate generally to providing a context for private messages, and more specifically to providing context data for feed items in instant messages.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows an example of a group feed on a group profile page according to some implementations.

FIG. 4 shows an example of a record feed on a record profile page according to some implementations.

FIG. 5 shows an example feed that provides context information for instant messages according to some implementations.

FIG. 6 shows the example feed of FIG. 5 providing different context information for instant messages according to some implementations.

FIG. 7 shows an example electronic mail message (email) feed that provides context information for instant messages according to some implementations.

FIG. 8 shows an example block diagram for a database system that provides feed and instant message services according to some implementations.

FIG. 9 shows an operational flow diagram illustrating a high level overview of a technique for inserting feed item context into instant messages according to some implementations.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for providing a context for private messages and, more specifically, to including the context of feed items including emails in instant messages.

A first user while accessing a feed system may request an instant message communication with a second user to discuss a targeted one of the feed items published on the feed system. The database system determines an identity of the second user and provides information identifying a context for the targeted feed item. The database system includes the context for the targeted feed item in an instant message communication established between the first user and the second user.

The context provided in the instant message communication may include any information that helps identify the targeted feed item, such as a portion of text from the targeted feed item, a file or link attached to the targeted feed item, a time stamp, a feed name or a subject line of the targeted feed item.

The context may help identify feed items referred to in instant message communications. The context may prevent users from having to manually type in additional background information for each instant message, thus enabling faster, shorter, and more understandable instant message communications.

In some implementations, the users described herein are users (or “members”) of an interactive online “enterprise social network,” also referred to herein as an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

### I. Example System Overview

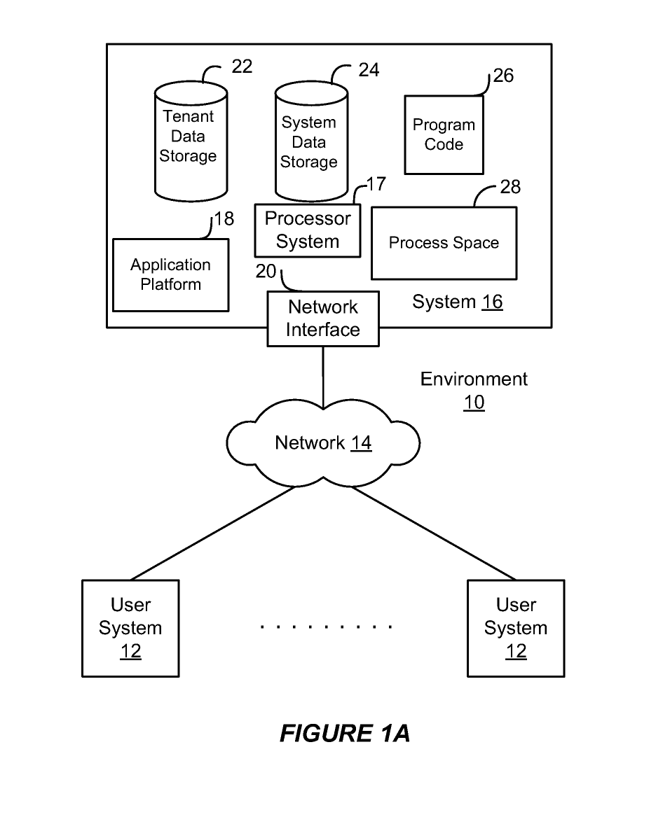

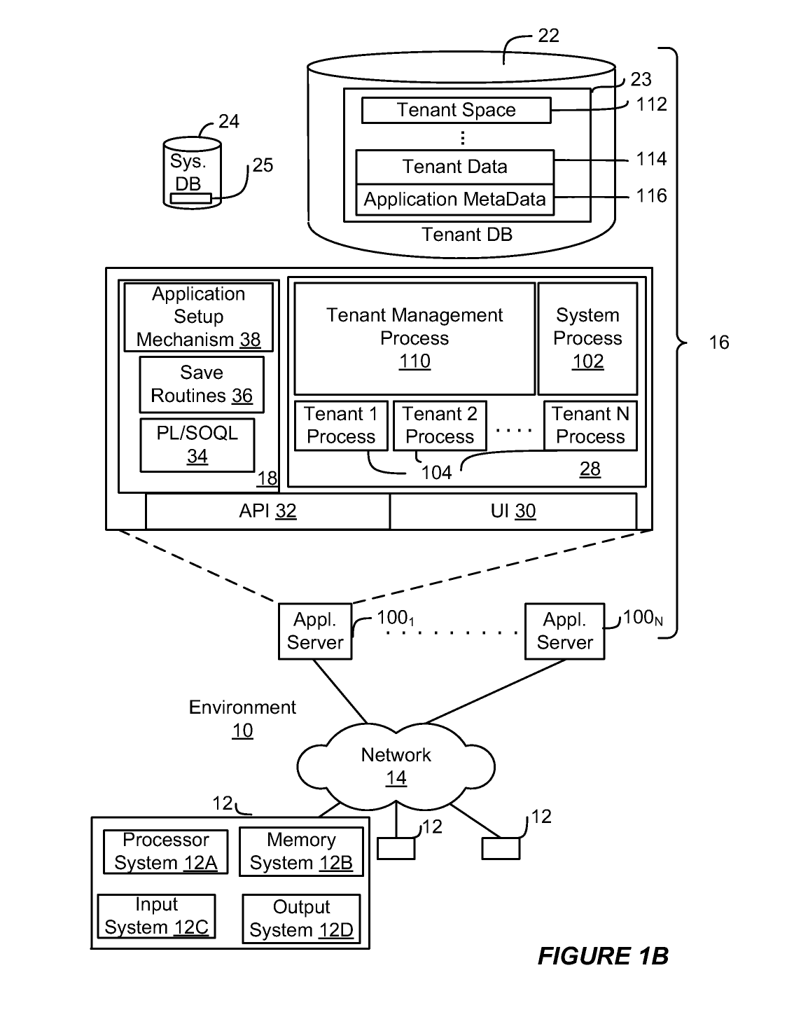

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

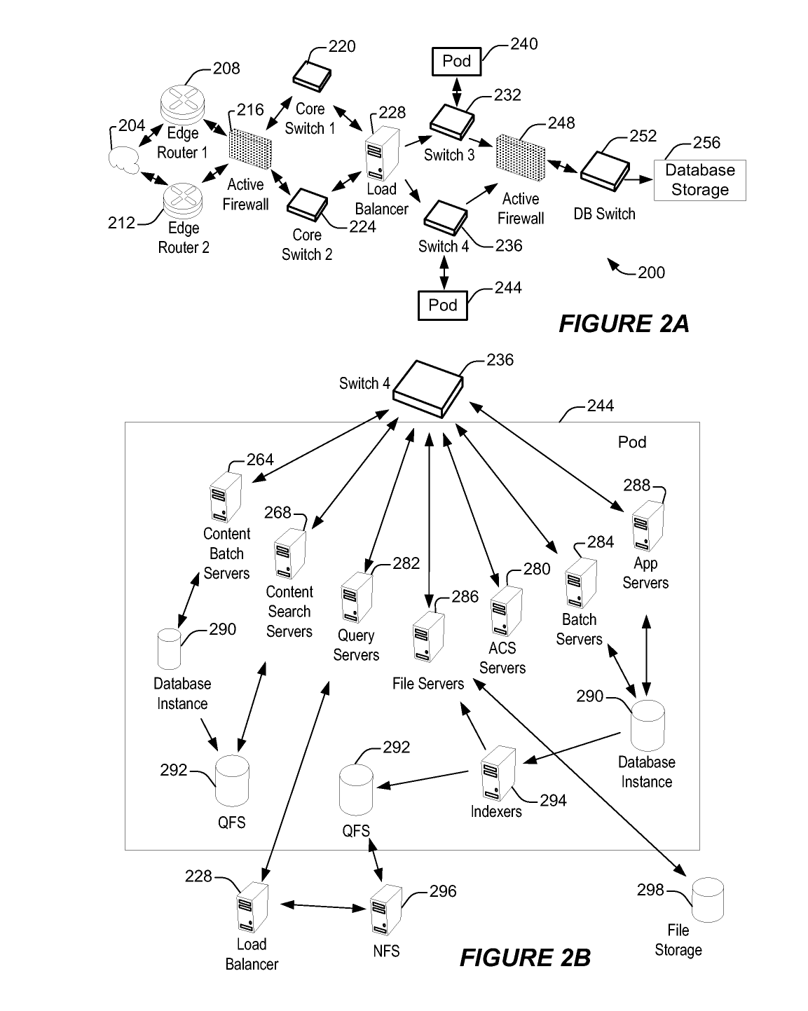

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

### II. Enterprise Social Networking

As initially described above, in some implementations, some of the methods, processes, devices and systems described herein can implement, or be used in the context of, enterprise social networking. Some online enterprise social networks can be implemented in various settings, including businesses, organizations and other enterprises (all of which are used interchangeably herein). For instance, an online enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). As described below, the data can include messages created by other users. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or group of users of the database system 16. Such records can include, for example, data objects representing and maintaining data for accounts, cases, opportunities, leads, files, documents, orders, pricebooks, products, solutions, reports and forecasts, among other possibilities. For example, a record can be for a business partner or potential business partner (for example, a client, vendor, distributor, etc.) of a user or a user's organization, and can include information describing an entire enterprise, subsidiaries of an enterprise, or contacts at the enterprise. As another example, a record can be a project that a user or group of users is/are working on, such as an opportunity (for example, a possible sale) with an existing partner, or a project that the user is trying to obtain. A record has data fields that are defined by the structure of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages, files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed items object is a data structure that can be represented or conceptualized as a “Feed Items Table” that associates users, records and groups to posts, comments, documents or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

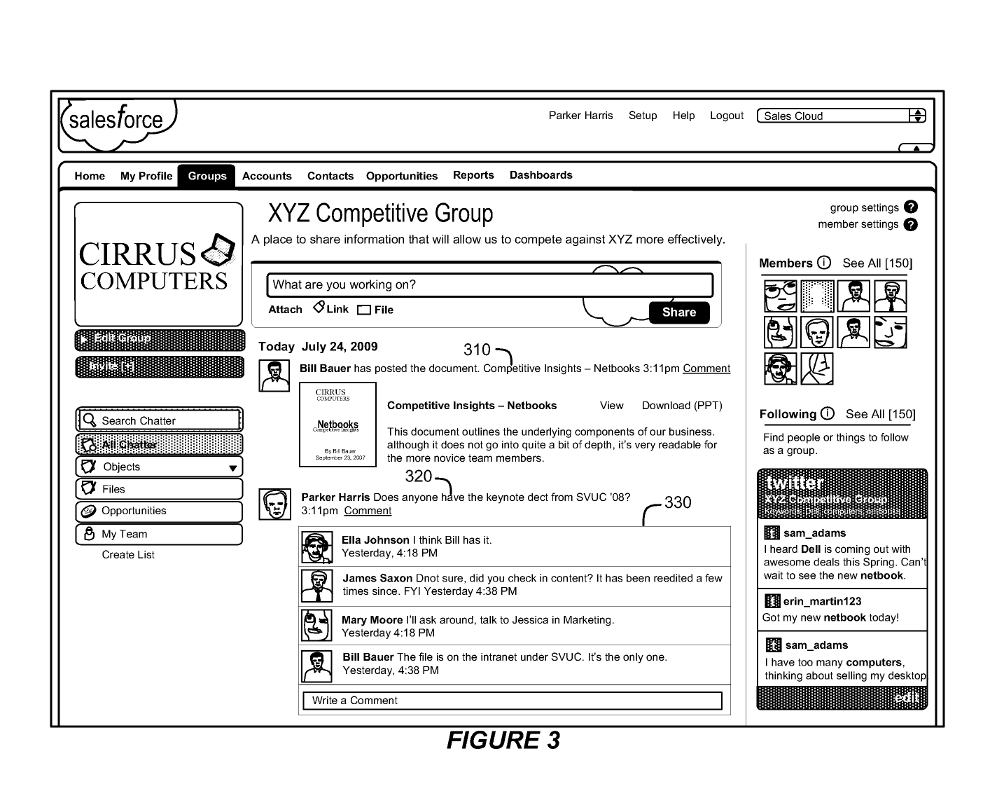

FIG. 3 shows an example of a group feed on a group profile page according to some implementations. As shown, a feed item 310 shows that a user has posted a document to the group feed. The text “Bill Bauer has posted the document Competitive Insights” can be generated by the database system in a similar manner as feed-tracked updates about a record being changed. A feed item 320 shows a post to the group, along with comments 330 from Ella Johnson, James Saxon, Mary Moore and Bill Bauer.

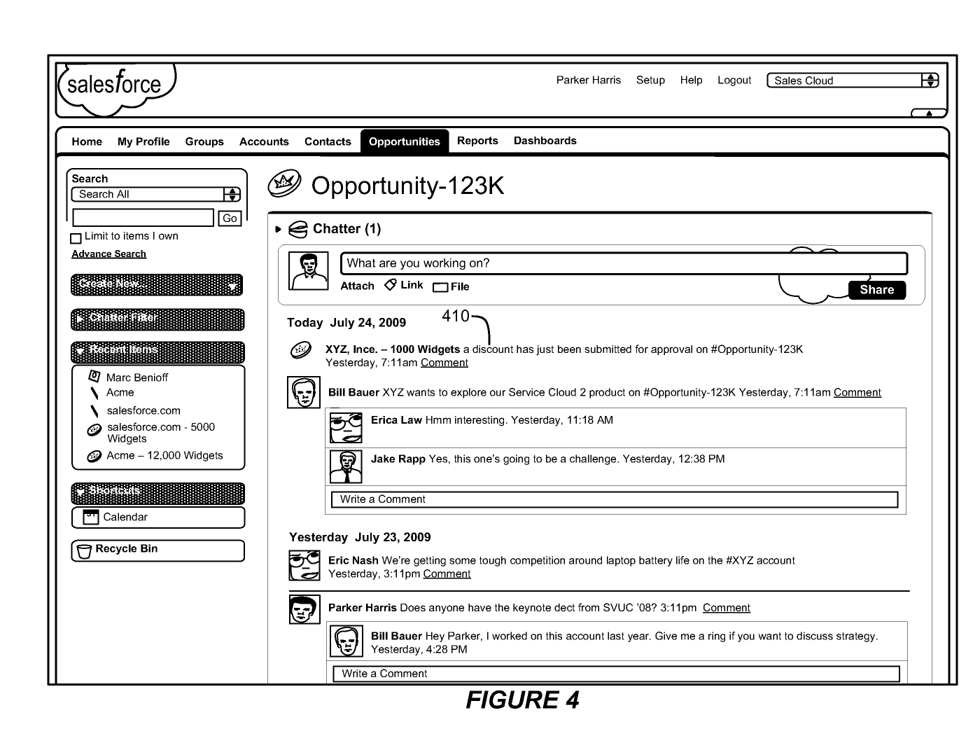

FIG. 4 shows an example of a record feed on a record profile page according to some implementations. The record feed includes a feed-tracked update, a post, and comments. Feed item 410 shows a feed-tracked update based on the event of submitting a discount for approval. Other feed items show posts, for example, from Bill Bauer, made to the record and comments, for example, from Erica Law and Jake Rapp, made on the posts.

### III. Adding Feed Context to Instant Messages

A first user may initiate an instant message communication with a second user to discuss a particular item posted on a social network. The second user may read the instant message communication but not realize the instant message is referring to a previously posted item. In other words, the instant message is not associated with any particular posted item on the social network.

The first and second user may exchange a series of instant messages to first identify a particular posted item on the social network. Exchanging multiple instant messages just to identify a posted item may negate some advantages of instant messaging, such as relatively short and quick real-time communications.

The database system described above may operate with an associated instant message system. The database system may provide the instant message system with information associated with different feed items. The instant message system may include the information associated with the feed items in instant messages to provide a context for the instant message communication.

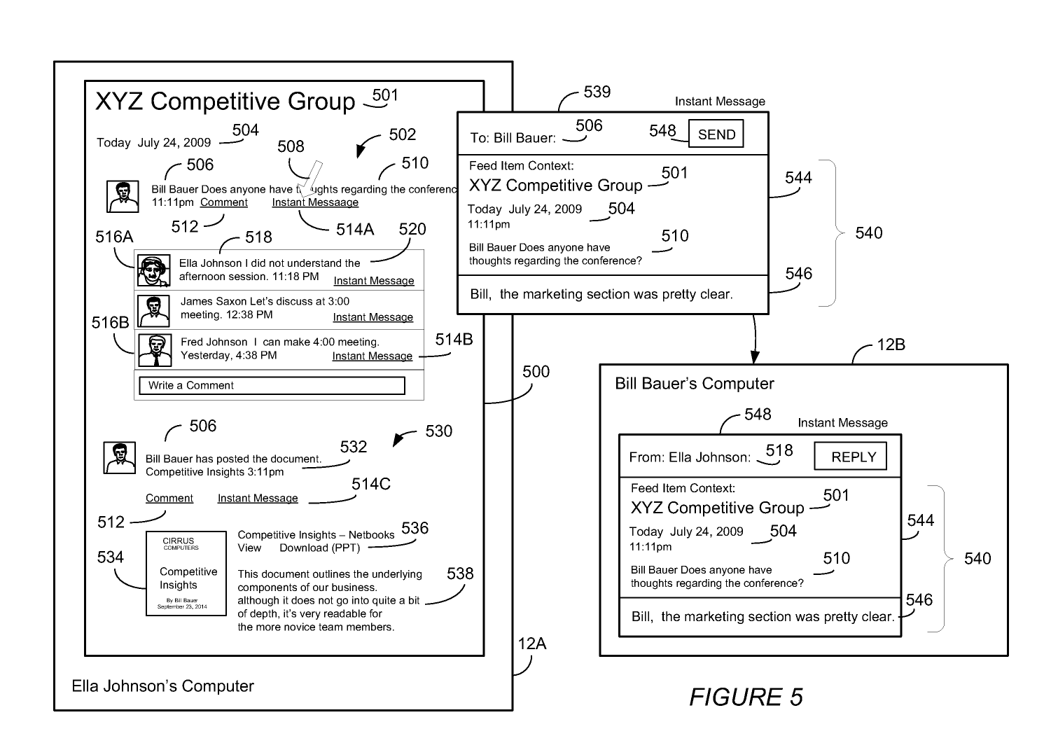

FIG. 5 shows an example feed providing context information for instant messages according to some implementations. Database system 16 in FIG. 1A may display information from a feed 500 on a screen of user system 12A. Feed 500 may include a feed name 501 for an associated entity, such as a profile, record, network, group, etc. Feed 500 also may include a variety of different feed items, such as a post 502 and a post 530. A time stamp 504 may indicate when posts 502 and 530 were published on feed 500.

Post 502 may include an associated user name 506, message 510, and time. User name 506 may identify a user or other entity that created or posted message 510. The time stamp indicates when post 502 was published on feed 500. Posts 502 and 503 may include any other feed items mentioned above, such as links, documents, attachments, files, images, audio, video, comments, updates, etc. The post may also indicate individuals whose attention to the post has been solicited by including their identifier such as @name which may results in emails or other notifications through a separate application to the indicated individual to draw their attention to the post.

Users may generate comments 516 for post 502 by selecting a comment icon 512. Comments 516 may include a user name 518 and a message 520. Comments 516 also may include a time and/or date or @name when published on feed 500 or any other feed items as explained above.

In this example, post 502 and post 530 are created or posted by the same user and include the same user name 506. A message 532 in post 530 identifies a document posted by the user. Post 530 includes an image 534 of the document, a title 536 for the document, and icons for viewing or downloading the document. Post 530 also includes a message 538 from the posting user describing the document. A user may select an icon 512 to create a comment for post 530.

These are just examples of any variety of feed items that the database system may publish in feed 500. Feed items may include any of the items explained above including, but not limited to, posts, comments, updates, announcements, records, objects, messages, documents, links, text, attachments, or any other type of data or information.

The database system may associate instant message icons 514A and 514C with posts 502 and 530, respectively. The database system may initiate an instant message communication in response to a selection of icon 514A or icon 514C. For example, a user may move a cursor 508 over icon 514A and click a mouse button or the user may select an enter key on a keyboard to select the icon. In another example, the database system may display a drop down menu that includes icon 514A in response to the user hovering cursor 508 over user name 506.

In response to selecting icon 514A, the database system may first identify the user associated with post 502. For example, the database system may determine that user Bill Bauer is associated with post 502 because Bill Bauer authored the post. Alternatively for example if the post was directed to Bill Bauer by an “@Bill_Bauer” and the subject of the post is a matter with which Bill Bauer is associated in the database system such as the subject is the name of a company for which Bill Bauer is a sales representative, the post may be associated with Bill Bauer. The database system then may determine if Bill Bauer is currently logged onto the database system or specifically logged onto feed 500 or viewing the feed 500. If logged in, the database system may determine the IP address and port for the user system 12B currently used by Bill Bauer. Alternatively, the database system may be able to identify the address and port for the user system 12B from other servers such as the network management system with which the database is associated.

The database system then may cause the opening of a window 539 on the display of user system 12A for sending an instant message (IM) 540. The database system may display user name 506 associated with post 502 in window 539. The database system may add context data 544 from post 502 into IM 540. Examples of context data 544 may include feed name 501, publish date and/or time 504 for post 502, and/or a portion of message 510 from post 502 such as the subject or the name of entities identified within the message. Various text parsers or text parsers with data mapping that are known to those of skill in the art may be used for selecting context data. Alternatively, the system may suggest context data and allow the user initiating the message to select among the suggested context data or add their own context data. The user initiating the instant message communication also may enter a message 546 into IM 540. In one example, message 546 discusses post 502.

Context data 544 may include any information or any portion of a feed item associated with post 502, including, but not limited to, any combination of images, videos, files, text, times, dates, subject, titles, names, electronic documents, electronic files, audio files, attachments, links, messages, snap shots, hashtags, updates, or the like, or any combination thereof

In response to selecting a send icon 548, the database system through the instant message system sends IM 540 to user system 12B. The database system opens another window 548 in user system 12B and displays name 518 of the user sending IM 540. In this example, the user that posted comment 516A also sends IM 540 and the database system displays name 518 in window 548.

Context data 544 provides a context for message 546. For example, context data 544 explains message 546 is referring to post 502 from feed 500. Specifically in this example, context data 544 indicates message 546 is likely referring to a marketing section of a conference mentioned in message 510 of post 502. Context data 544 may prevent confusion when referring to feed items. For example, context data 544 clarifies that message 546 is referring to the conference referenced in post 502 and not referring to the document referenced in post 530.

The database system may automatically insert context data 544 into IM 540. This prevents a user from having to manually type additional text into message 546 explaining the conference referenced in post 502. Thus, users may send shorter, faster, clearer, and/or more efficient IM messages. In one example, IM message 540 is private. Users can quickly discuss feed items in instant messages without database system publishing the instant messages in feed 500.

In one example, the database system might not display IM icons 514 for users that are not currently logged-in to the database system or feed 500. For example, if Bill Bauer is not currently logged in to the database system or not logged into the applicable network, the database system may display icons IM icons 514A and 514C in a different color. Alternatively, the database system may display user name 506 in a different color to indicate Bill Bauer is currently logged-in or not logged-in to feed 500.

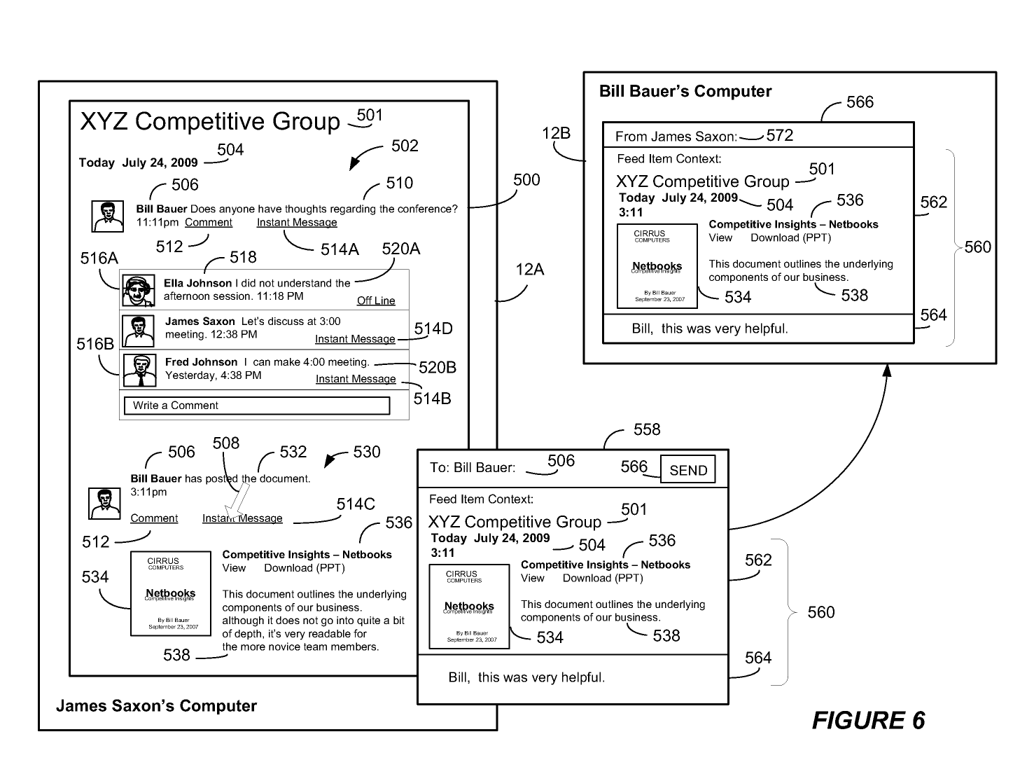

FIG. 6 shows the example feed of FIG. 5 inserting context information for another feed item into an instant message. In this example, a user James Saxon selects IM icon 514C with cursor 508. The database system determines user Bill Bauer is associated with post 530 and initiates an IM communication with Bill Bauer on user system 12B.

In this example, the database system opens a window 558 on user system 12A and displays name 506 for Bill Bauer. The database system inserts context data 562 from post 530 into IM 560. In this example, context data 562 may include name 501 of feed 500 and the date and time 504 post 530 was published on feed 500.

Context data 562 also may include image 534 and title 536 for the document attached to post 530. Context data 562 also may include at least a portion of message 538 from post 530 such as the first sentence or key words. The user on user system 12A also may add a message 564 to IM 560. For example, message 564 may indicate the document in post 530 was helpful.

In response to receiving information indication of the selection of a send icon 566 on system 12A, the database system may cause by transmitting information to cause the display IM 560 in a window 566 on user system 12B. The database system may identify a name 572 of the user sending the IM communication. Context data 562 indicates message 564 is associated with post 530 and specifically indicates that message 564 is referring to the competitive insights document attached to post 530. Context data 562 prevents confusion by clarifying message 564 is likely referring to the document in post 530 and not referring to the conference referred to in post 502.

The database system may associate instant messages with any feed item in feed 500. For example, the database system may associate instant messages with different comments 516. The user of user system 12A (James Saxon) may select an IM icon 514B associated with comment 516B posted by Fred Johnson. The database system may determine if Fred Johnson is logged-in to feed 500 or the associated computer network. If so, the database system opens another IM window 558 in user system 12A and generates the information to cause the display of context from comment 516B into the IM window. James Saxon then enters another message 564 into the new IM window 558. The database system through the IM system, or the IM system alone sends the instant message from user system 12A to the user system associated with Fred Johnson so that system 12A upon receipt and processing of the received instant message will permit the display of a window displaying the instant message.

The database system may include a portion of comment 516 and/or a portion of associated post 502 as context data. For example, the context data may include a portion of message 510 from post 502, a portion of message 520B from comment 516B, or both. The context data also may include any document or file attached to post 502 or comment 516B.

In another example a first user may want to initiate an instant message with a second user regarding a feed item posted by a third user. The first user may first select a name or other identifier associated with the second user to initiate the instant message communication. The first user then may select the feed item posted by the third user. The database system then includes the context data for the selected feed item with the instant message communication between the first and second user.

For example James Saxon may select user name 506 to initiate an instant message communication with Bill Bauer. James Saxon then may select comment 516A causing the database system to include a portion of message 520A into the instant message communication with Bill Bauer.

The database system may organize the instant messages based on context data 562. For example, the database system may identify all of the instant messages that include the same feed title 501 or include a same feed item identifier. The database system may store all of the identified IMs in a given directory. A user may select the directory to view all IM communications associated with that feed item.

In another example, the database system may list the IMs in chronological order based on the post date and time 504 identified in context data 562. For example, the IMs with the most recent posting or comment date may be listed before IM files with older posting or comment dates.

In yet another example, the database system may initiate or cause to be initiated a group instant message communications based on items in feed 500. The database system may identify all of the users associated with a particular feed 500 or associated with a particular post 502 or some subset of the users based upon their position in the company heirarchy. For example, the database system may identify three users Bill Bauer, James Saxon, and Fred Johnson all associated with post 502 and all currently logged-in to feed 500. The database system may initiate a group chat session with the three users in response to selection of IM icons 514A, 514B, and 514D.

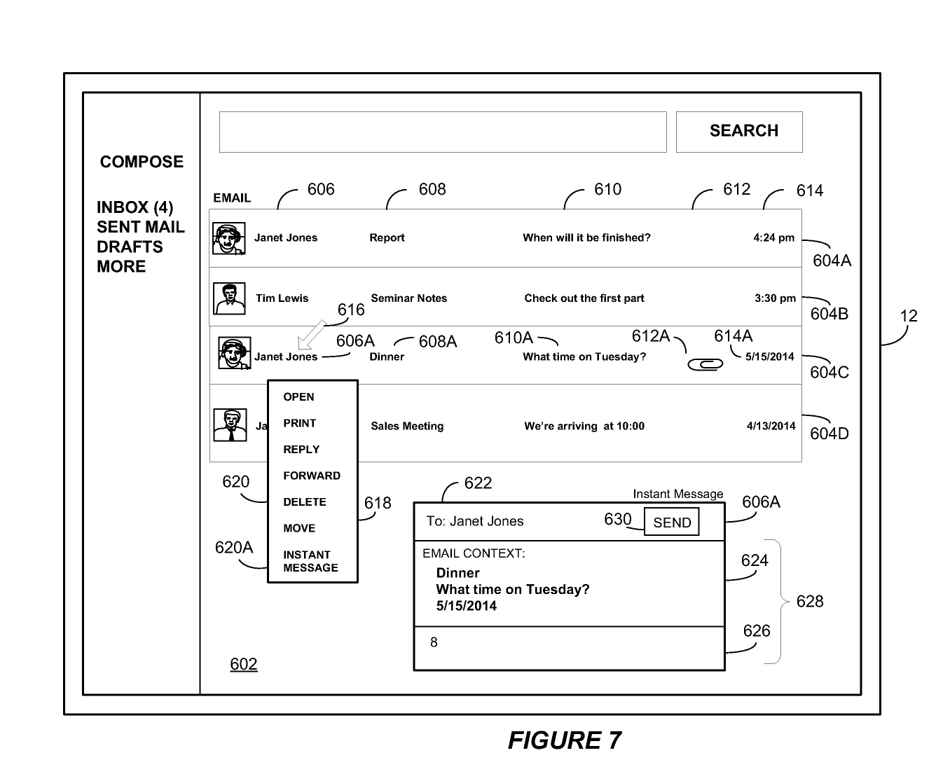

FIG. 7 shows an example electronic mail message (email) feed that provides context information for instant messages according to some implementations. In one example, the database system may operate or be associated with an email system 602. Email system 602 may display received emails 604 on a screen of user system 12. Email messages 604 may include a sender name 606, a subject 608, content preview 610, an attachment 612, and/or a receipt time 614.

A user may initiate an instant message with one of the senders of emails 604. For example, a user may use cursor 616 to select or hover over a name 606A of email 604C. The database system may display a drop down menu 618 in response to selecting name 606A. The drop down menu 618 may list different actions 620. Selecting action 620A may cause email system 602 to initiate an instant message communication with the sender of email 604C.

An instant message system associated with email system 602 determines if the user associated with email 604C is currently logged-in to the database system or the associated network. If so, the IM system opens a window 622 on the screen of user system 12A. The instant message system may display name 606A from email 604C in window 622. The instant message system also may include context data 624 from email 604C in instant message 628. Context data may include any information from email 604C, such as any combination of subject line 606A, content preview 610A, attachment 612A, and/or time stamp 614A. The user of user system 12 enters a message 626 into IM 628 and selects send icon 630.

In response to selecting icon 630, the instant message system sends IM 628 to the sender of email 604C. Context data 624 associates message 626 with email message 604C. For example, context data 624 notifies user Janet Jones that message 628 is responding to the dinner query in email 604C and not the report query in email 604A.

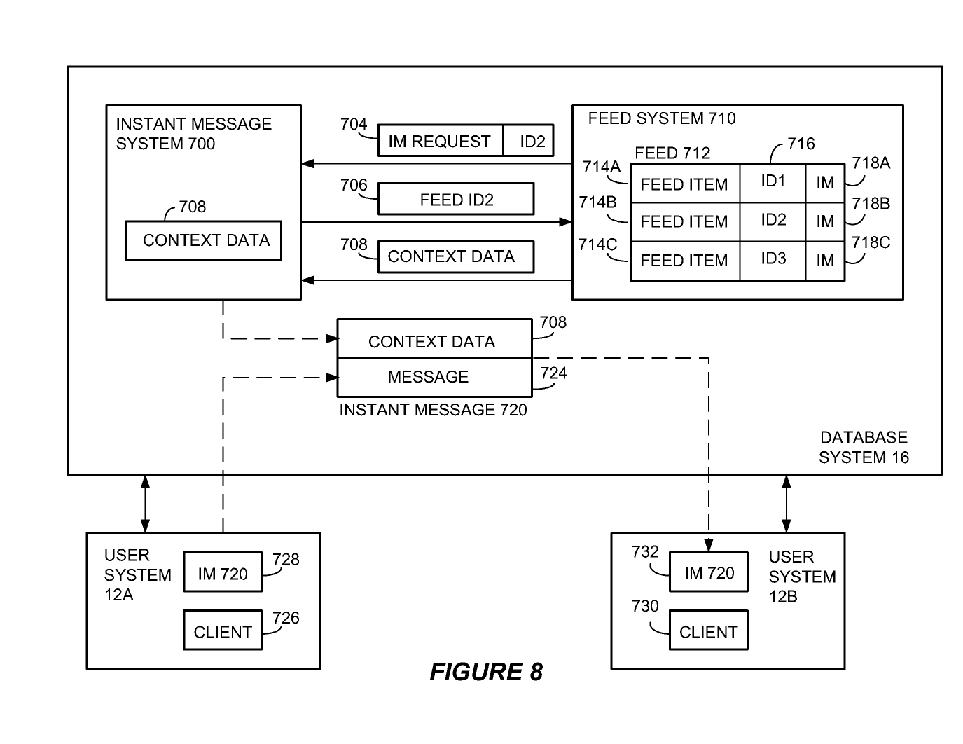

FIG. 8 shows an example block diagram for a database system that provides feed and/or instant message services according to some implementations. User systems 12A and 12B are connected to database system 16 as previously explained in

FIG. 1A. IM system 700 and feed system 710 may include any combination of hardware, software, and data as previously described above. Feed system 710 may operate feeds associated with different profiles, groups, records, or networks as described above.

In one example, instant message system 700 and feed system are shown operating within database system 16. In another example, IM system 700 may operate outside of database system 16 and communicate with feed system 710 via network 14 in FIG. 1A. Alternatively, IM system 700 may be part of a separate email system such as Gmail.

For explanation purposes, some operations are described generally as performed by the database system and other operations are described specifically as performed by instant message system 700 or feed system 710. However, any of these systems, or any other combination of hardware and software within database system 16, or external to database system 16, may perform any of the operations described above.

In one example, feed system 710 operates a feed 712 that currently includes three feed items 714A-714C. Feed items 714A-714C may have associated feed identifiers 716 specifically referred to as ID1, ID2, and ID3, respectively.

In one example, feed identifiers 716 are URLs that identify object locations for feed items 714 within database system 16. Database system 16 may use other identifiers or addresses for storing and identifying feed items 714. For example, feed identifiers 716 may identify objects, records, data structures, or any other item that associates users, records and groups to posts, comments, documents or other publications.

In this example, first and second users of user systems 12A and 12B, respectively, are logged-in to database system 16 and user system 12A is currently accessing feed 712 and displaying feed items 714 or are at least logged into the network and the network is capable of passing messages to and from the database system 16 and/or instant messaging system. Also in this example, the second user operating user system 12B is associated with feed item 714B. For example, the second user may have posted feed item 714B.

A client 726 on user system 12A may send database system 16 connection information, such as an assigned IP address and port number or alternatively that information may come from the network management system associated with the database system. Database system 16 may create a temporary contact list that contains the connection information for client 726 and clients for other users. Database system 16 may send the connection information to client 726 and to clients for other users in the contact list that are currently logged-in.

Feed items 714A-714C may have associated icons 718A-718C, respectively, for initiating associated instant message communications. As explained above, the database system may display icons 718 to indicate associated users are online. For example, the database system may display icon 718B or change a color of icon 718B to indicate the second user associated with feed item 714B is currently online.

The first user on user system 12A may initiate an instant message communication by selecting icon 718B for feed item 714B. In response to selecting icon 718 by the user, client 726 may open a chat window 728 on user system 12A and feed system 710 may send or cause to be sent an IM request 704 to IM system 700. In another example, feed system 710 may send IM request 704 to user system 12A and client 726 may forward the request to IM system 700.

Request 704 may include identifier ID2 for feed item 714B. IM system 700 uses identifier ID2 to access feed system 710 and locate feed item 714B. For example, IM system 700 may use application programmer interfaces (APIs) for feed system 710 to read feed item 714B. Feed system 710 may provide other identifiers to IM system 700 in request 704, such as the UserID, OrgID, RecordID, and/or GroupID described above.

As mentioned above, IM system 700 may read any context data 708 from feed system 710 that helps identify feed item 714B. For example, feed identifiers 716 may identify a profile, group, record, subject, or network associated with feed 712 and a particular feed item 714 within feed 712. IM system 700 may extract information from feed 712, such as a feed name and feed date. IM system 700 also may extract information from feed item 714B, such as a message, link, document, name, time, date, update, etc. In another example, feed system 710 may send context data 708 directly to IM system 700 in IM request 704. Alternatively, the feed system may extract the information and provide the information to the database.

IM system 700 inserts context data 708 into instant message 720. For example, IM system 700 may send context data 708 to client 726 and client 726 may display context data 708 in window 728. The first user on user system 12A then may enter a message 724 into window 728. The first user also may add, delete, and/or modify context data 708 displayed within window 728.

The first user selects a send icon in window 728 (not shown) or hits return on a keyboard causing client 726 to send IM 720 to client 730 on user system 12B. Client 730 displays IM 720 in window 732. As explained above, context data 708 associates message 724 with feed item 714B. Thus, the second user on user system 12B may better understand the context behind message 724.

Context data 708 may prevent the second user from having to search for documents or files. For example, context data 708 may include a link or attachment for a file attached to or associated with feed item 714B. The second user on user system 12B can view the link or attachment in IM 720 without having to search for the file in feed system 710.

In another example, database system 16 may transmit instant messages 720 between a group of users associated with feed 712. In yet another example, database system 16 may transmit instant messages 720 between different groups of users associated with different feeds 712 operating within database system 16.

For example, a first feed 712 may be associated with a group within enterprise, a second feed 712 may be associated with a social network within or without the enterprise, and a third feed 712 may be associated with an email service. The database system 16 may initiate IMs 720 between the users associated with the different feeds 712. The database system may include context data 708 with the IMs 720 that identify both the associated feed items 714 and the feed 712 where the instant message communication was initiated.

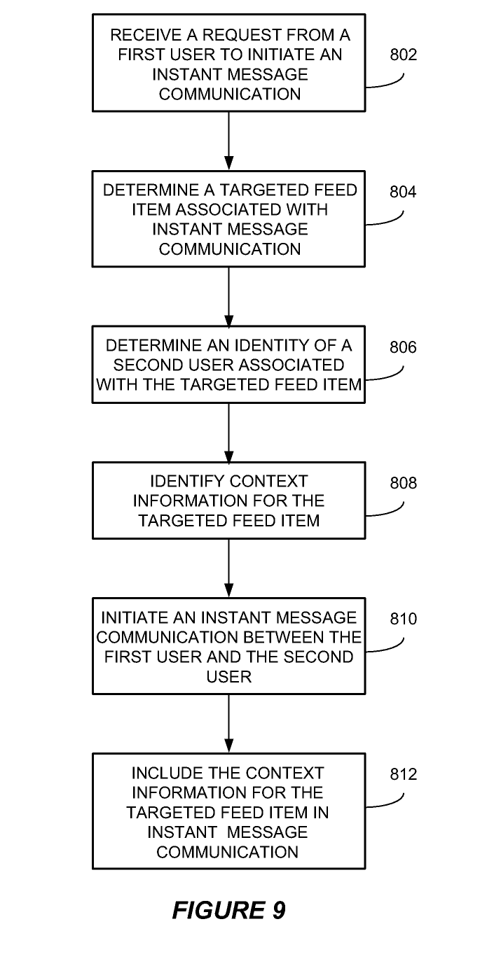

FIG. 9 shows an operational flow diagram illustrating a high level overview of a technique for inserting context into instant messages according to some implementations.

In operation 802, the database system receives a request from the computing device operated by a first user to initiate an instant message communication. For example, the first user selects an instant messaging icon associated with a particular feed item or alternatively with an instant messaging icon that when selected causes the display of a pick list for selecting the particular feed item to be associated with the instant message.

In operation 804, the database system determines a target feed item associated with the instant message communication. For example, the database system may identify the URL for the feed item selected by the user.

In operation 806, the database system determines an identity of a second user associated with the targeted feed item. For example, the database system may identify a name of a user that posted the targeted feed item. Alternatively, the database system may use tables storing corporate hierarchy information associated with names in the posting item such as direct managers or all members of a particular team. Alternatively, the database system may identify all users of the database enterprise system who have indicated to the database system that they are interested in a particular subject or entity identified in the posting. The database system may identify an Internet protocol (IP) address/email address associated with the identified name or names.

In operation 808, the database system identifies context data for the targeted feed item. As explained above, the database system may extract any information that provides a context or any other type of summary or information associated with the targeted feed item.

In operation 810, the database system may initiate the instant message communication between the first user and the second user. For example, the database system may open up a first chat window on the user system of the first user.

In operation 812, the database system may include the context information for the targeted feed item in the instant message communication. For example, the database system may insert the context information into the chat window. The first user then may enter a message into the chat window and select a send command The database system sends the instant message to the user system of the second user. The instant message includes both the context information and the message from the first user.

The examples described above refer to instant message communications. However, it should be understood that context information can be extracted from any communication, message, or data associated with any type of networking system, social media system, enterprise platform, database system, etc. and inserted into any type of real-time, private, chat, instant message, and/or point-to-point communication.

The types of context information associated with feed items may be configurable. Either a network administrator or user may determine what types of context data to insert into associated instant messages. For example, a first user may configure the database system to include a feed title and a portion of text from the feed item message in the context information. A second user may configure the database system to include links to documents attached to the feed item. In another example, the feed administrator may configure the database system to include a specified number of characters, words, or lines from the targeted feed items in the context information.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer program stored on a tangible medium for a database system for generating a social network including providing information to cause to be generated on a display of a remote computing device associated at least temporarily with a first user a feed of items, with at least one of the feed of items being associated with a second user of the database system and the database system being associated with an instant message system, the computer program comprising a set of instructions operable to:
receive at the database system a request from the first user of the remote computing device, the request initiated by the first user in association with the feed of items to initiate an instant message communication through the instant message system with a second user;
determine at the database system a target feed item from the feed of items associated with the request;
determine at the database system an identity of the second user associated with the target feed item;
provide from the database system information identifying a context of the target feed item; and
cause the database system to initiate through the instant message system the establishment of the instant message communication between the first user and the second user and causing the context of the target feed item to be included in the instant message communication.

2. The computer program as recited in claim 1, wherein the context includes a universal resource locator (URL) for the target feed item.

3. The computer program of claim 1, wherein the context includes a portion of text from the target feed item.

4. The computer program of claim 1, wherein the context includes an electronic document posted with the target feed item.

5. The computer program of claim 1, wherein the context includes a link to an audio, video, and/or image file associated with the target feed item.

6. The computer program of claim 1, further comprising instructions operable to cause a private message from the first user to be included in the instant message communication.

7. The computer program of claim 1, wherein:
one of the feed of items comprises a posted feed item;
the target feed item comprises a comment to the posted feed item; and
the context of the target feed item includes a portion of the posted feed item and a portion of the comment to the posted feed item.

8. The computer program of claim 1, wherein the target feed item comprises an electronic mail message (email) and the context of the target feed item comprises a portion of the email message.

9. The computer program of claim 1, further comprising instructions operable to:
determine at the database system an identity of a feed associated with the target feed item; and
cause the database system to include the identity of the feed in the context of the target feed item.

10. A method for a database system of inserting context into instant messages, comprising:
causing by the database system a feed of items from a feed system to be displayed on a screen of a remote computing device associated with a first user, with the database system being associated with an instant message system;
receiving at the database system through the feed system a request from the first user to initiate an instant message communication;
determining at the database system a target feed item from the feed of items associated with the request;
determining at the database system an identity of a second user associated with the request;
providing from the database system context data for the target feed item; and
causing the database system to initiate through the instant message system the establishment of the instant message communication between the first user and the second user and include the context data for the target feed item in the instant message communication.

11. The method of claim 10, further comprising:
causing the database system to provide the instant message system an identifier associated with the target feed item;
receiving at the database system a request from the instant message system including the identifier; and
providing by the database system the context data in response to the request from the instant message system.

12. The method of claim 10, further comprising:
causing the database system through the instant message system to display an instant message window on the screen of the remote computing device; and
causing the database system through the instant message system to display the context data within the instant message window.

13. The method of claim 10, further comprising causing the database system through the instant message system to include the context data with a message from the first user in the instant message communication.

14. The method of claim 10, wherein the target feed item comprises a post and the context data includes information from the post.

15. The method of claim 10, wherein the target feed item comprises a comment associated with a post and the context data includes information from the post and information from the comment.

16. The method of claim 10, wherein the context data includes a link to an electronic document attached to the target feed item.

17. The method of claim 10, further comprising:
causing the database system to identify a third user associated with the target feed item; and
causing the database system to initiate through the instant message system a group instant message communication between the first user, the second user, and the third user and causing the context data for the target feed item to be included in the group instant message communication.

18. A database system, comprising:
a processing system; and
a memory device coupled to the processing system configured to store feed items for a feed system operated by the database system, with the database system causing a display of at least some of the feed items for the feed system on a remote computing device, the memory device having instructions stored thereon that, in response to execution by the processing system, are operable to:
receive through the feed system a request from the remote computing device to initiate a private message communication;
determine at the feed system a target feed item from the feed items associated with the request from the remote computing device;
determine at the feed system a user associated with the private message communication;
provide from the feed system context information for the target feed item; and
initiate through the feed system the private message communication with the user and cause the context information for the target feed item to be included in the private message communication.

19. The database system of claim 18, wherein the instructions are further operable to:
receive at the feed system a selection of the target feed item;
cause the feed system to initiate the private message communication and provide an identifier of the target feed item to an instant message system in response to the selection of the target feed item.

20. The database system of claim 19, wherein the instructions are further operable to:
receive at the feed system a request from the instant message system for the context information associated with the target feed item; and
provide from the feed system to the instant message system the context information in response to the request from the instant message system.

21. The database system of claim 18, wherein the target feed item comprises a post on the feed system and the context information comprises a portion of the post.
